(19) United States
(12) Patent Application Publication
(10) Pub. No.: US 2005/0128892 A1
(43) Pub. Date: Jun. 16, 2005

(54) Apparatus and method for controlling the disc loading/ejecting operation in an optical disc drive

(75) Inventors: Tsung-Jung Kuo, Hsinchu (TW); Jui-Chiang Lin, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Lite-On It Corporation

(21) Appl. No.: 11/006,088

(22) Filed: Dec. 7, 2004

(30) Foreign Application Priority Data
Dec. 12, 2003 (TW) 92135165

(51) Int. Cl. G11B 7/085

(52) U.S. Cl. 369/30.27

(57) ABSTRACT

An apparatus for controlling the disc loading/ejecting operation in an optical disc drive that has a turntable and is able to access a larger disc and a smaller disc. By utilizing two sensors, it can be detected whether an optical disc passing the positions corresponding to those two sensors or not. Moreover, a logical element for managing the loading/ejecting operation according to the outputs of the first and the second sensors controls a motor to drive a roller to load or eject the optical disc. Besides, a method for controlling the disc loading/ejecting operation accordance with the apparatus mentioned above is also disclosed. The outputs of those two sensors are referenced, and choice for performing loading or ejecting operations is determined according to the transition of the outputs of the sensors.

### BACKGROUND OF THE INVENTION

1. Field of the Invention

The present invention relates to optical disc drives, and more particularly, to an apparatus and a method for controlling the disc loading/ejecting operation in an optical disc drive.

2. Description of the Related Art

With the developments of information technology and the widespread utilization of multimedia contents, the demanding for data storage solutions with high capacities and low costs raises day by day. Among all the data storage solutions, the optical discs are becoming more and more important for backing up data and exchanging information due to many advantages that the optical storage media have that includes a high data capacity, portability, and a long lifetime for preserving information. Currently, the optical disc drives are widely used such in desktop computers, laptop computers, DVD players, and some instruments or electronic products with built-in microprocessors.

Generally speaking, an optical disc drive loads or ejects an optical disc by utilizing a disc loading mechanism of the optical disc drive. After loading the optical disc into the optical disc drive, the optical disc is fixed to a turntable of a spindle motor for further data access. Besides the conventional tray loading mechanism, the slot loading mechanism is getting more and more popular for its convenience. It is quite handy for users to just insert a disc slightly into the loading/ejecting slot, and then the slot loading mechanism of the optical disc drive takes over the following loading process. Moreover, while loading or ejecting a disc with the slot loading mechanism, the slot loading mechanism can hold the disc firmly throughout all the loading or ejecting process. Thus it makes the slot loading mechanism especially suitable for using in a moving or vibrating environment such as car-use CD audio players and databases for GPS navigators.

Please refer to FIG. 1. FIG. 1 is a top view for illustrating the relation between various elements in an optical disc drive with slot loading mechanism of the prior art after a disc has been loaded. A prior art optical disc drive 100 has a loading/ejecting slot 102, a first sensor 112 disposed at a first sensing position for detecting if a disc passing the first sensing position, and a second sensor 114 disposed at a second sensing position for detecting if a disc passing the second sensing position. There are also two round contours in FIG. 1 for showing the positions of two regular sizes of the loaded optical disc: one is for a larger disc with 12 cm diameter 120, and the other is for a smaller disc with 8 cm diameter 130. The first sensor 112 is designed to trigger the loading operation and to help to decide if a loaded disc is a 12 cm disc. Thus a distance R1 between the center of the turntable and the first sensing position for deposing the first sensor 112 is larger than the radius of the 8 cm disc 130 and smaller than the radius of the 12 cm disc 120. Furthermore, after a disc is loaded into the disc drive, the disc is fixed on a turntable 108 of the spindle motor. A logical element (Not Shown) manages the status of the loading/ejecting operation according to the outputs of the first and the second sensors and controls a motor (Not Shown) to drive a roller 104 via a gear set 106 to load or eject the optical disc. The roller 104 is used to convey optical discs into or out of the disc drive according to the rotating direction of the roller. The position of the roller 104 is set to overlap with the covering range of both the 8 cm disc 130 and the 12 cm disc 120 to ensure that the roller 104 can convey those tow kinds of discs with different radiuses as specified in the specification.

Moreover, some components are not described in detail for the sake of not to unnecessarily obscure the description of the present invention. As shown in FIG. 1, whether a user is inserting a 12 cm disc 120 or a 8 cm disc 130, the second sensing position in a prior art would be designed within the covering range of the 8 cm disc 130 so that the output of the second sensor 114 could provide a reference to determine if there is an optical disc inside the optical disc drive or not. Meanwhile, combining the output of he first sensor 112, the size of a loaded optical disc can also be determined. For example, while the loaded disc is a 12 cm disc 120, both sensors 112 and 114 can sense the disc. And when the loaded disc is an 8 cm disc 130, only the second sensors 114 senses the disc.

The sensors as mentioned above can be electronic switches that includes leaf springs or rods with a HIGH level and a LOW level logical states for indicating whether a disc has been detected. And in the preferred embodiment, the above mentioned sensors are optical sensors that each has an emitter and a receiver to emit and receive a light beam, respectively. For example, when a disc is passing an optical sensor, the light beam from the emitter is blocked by the disc and the sensor has an out put at the LOW level. On the other hand, when the sensor is not blocked by the disc, the sensor has an out put at the HIGH level. Of course the output levels of a sensor can be easily redesigned to have a HIGH level output when the sensor is blocked, and to have a LOW level output when the sensor is not blocked. Furthermore, the logical element for managing the loading and ejecting operations can be a hard-wired logic circuitry or a microprocessor executing a firmware. And in some embodiments, the logical element can even share the same PCB with the first and the second sensor.

Now refer to FIG. 2A. FIG. 2A is a top view for illustrating the optical disc drive with slot loading mechanism of the prior art when a disc has just been inserted into the loading/ejecting slot 102. While a 12 cm disc 120 or an 8 cm disc 130 has been inserted into the loading/ejecting slot 102, the logical element (Not Shown) recognizes that the disc should be loaded into the disc drive if the disc blocks the first sensor 112. Then the logical element gives instructions to drive the roller 104 for conveying the disc into the drive and fixed the disc on the turntable. To allow users being able to insert a 12 cm disc from every angle, the first sensor 112 is usually disposed near the loading/ejecting slot 102 and around the center of the optical disc drive 100. More specifically, the first sensor 112 is usually disposed on the virtual line between the center of the turntable and the center of the loading/ejecting slot 102.

The position of the first sensor 112 of the prior art is disposed close to the roller 104 as shown in FIG. 2A. This arrangement allows the first sensor 112 being blocked by the disc after the disc has been ejected whether a 12 cm disc 120 or an 8 cm disc 130 is used. Such that once the disc has been removed by the user after ejection, the first sensor 112 can be prepared for the next loading operation by simply determining if the status of the first sensor 112 has been changed from block to unblock after the eject operation. However, users have to insert the disc into a deeper position to block the first sensor 112 and trigger the loading operation according to prior art design. Please refer to FIG. 2B. FIG. 2B is a top view for illustrating the optical disc drive with slot loading mechanism of the prior art when an 8 cm disc has been inserted into the loading/ejecting slot 102 sidelong. Furthermore, when an 8 cm disc 130 has been inserted into the loading/ejecting slot 102 but not through the middle of the loading/ejecting slot 102, the 8 cm disc 130 could have touched the roller 104 without initiate the loading operation. This raises lots of inconvenience to users for using an optical disc drive with slot loading mechanism.

Please refer to FIG. 3A. FIG. 3A is a top view for illustrating the optical disc drive with slot loading mechanism of the prior art when an 8cm disc 130 or a 12 cm disc 120 has been ejected from the optical disc drive. As shown in the diagram, the second sensor 114 can be used to decide when to stop the roller 104 during the ejecting operation. When the logical element receives commands to eject a disc inside the optical disc drive, the logical element gives instructions to drive the roller 104 for conveying the disc out of the drive 100 until the second sensor 114 no longer being blocked by the disc. Since the second sensor 114 can also help to determine if there is a disc inside the optical disc drive 100 or not, the distance R2 between the center of the turntable and the second position for deposing the second sensor 114 should be less than the radius of an 8 cm disc. Concerning the layout of mechanical and electronic components, the second position is usually at a side of the virtual line between the centers of the turntable and the loading/ejecting slot 102. Moreover, for users to handle the disc after ejecting operation, a distance D between the second sensor 114 and the loading/ejecting slot should be less than the diameter of an 8 cm disc 130. And a distance L between the second sensing position and the first sensing position should be less the radius of an 8 cm disc 130 to ensure that the first sensor 112 can be blocked when the ejecting operation has just done.

Please refer to FIG. 3B. FIG. 3B is a time diagram illustrating the output of the first sensor 112 in an optical disc drive with slot loading mechanism of the prior art after an ejecting operation is performed. At the time point A, the second sensor 114 has just been unblocked (for example, a HIGH level output, not shown in FIG. 3B) and the ejecting operation has just been done. Thus the roller 104 stops to convey the disc, and the disc blocks the first sensor 112 (for example, a LOW level output) at this time no matter an 8 cm disc 130 or a 12 cm disc 120 being ejected. Then users remove the disc from the disc, the first sensor 112 will become unblocked and output a HIGH level logical state. After that, if users further want to insert a disc into the optical drive again at time point B, a disc can be inserted into the loading/ejecting slot. When the logical element finds that the output from the first sensor 112 has changed from a HIGH level to a LOW level, which it also means that the first sensor 112 is blocked by the disc again, the logical element can initiate a loading operation to convey the inserted disc into the drive.

Please refer to FIG. 4. FIG. 4 is a flow chart illustrating the method for controlling the disc loading operation in an optical disc drive with slot loading mechanism of the prior. Presume that there is no disc inside the optical disc drive 100 at beginning according to the flow chart. In step 402, when the first sensor 112 output a HIGH level logical state (sensor unblocked) and the second sensor 114 HIGH level logical state (sensor unblocked), it indicates that there are no discs inside the optical disc drive 100 for the logical element. Then in the step 404, the logical element monitors if the logical state of the first sensor 112. Once the first sensor 112 outputs a LOW level logical state (sensor blocked), the progress moves into step 406 and the logical element gives instructions to drive the roller 104 to perform a loading operation. After the loading operation is done, the progress moves into step 408 and the output of the second sensor 114 should be at LOW level logical state (sensor blocked). Following, in the step 410, the logical element monitors if an ejection command is received. If an ejection command is received, the progress proceeds to step 412 and the logical element gives instructions to drive the roller 104 to perform an ejecting operation until the second sensor 114 outputs a HIGH level logical state (sensor unblocked). After user removes the disc, the progress goes back to step 402.

Therefore, apparatus and method for controlling the disc loading/ejecting operation in an optical disc drive as mentioned above requires users to insert a disc deeper into the loading/ejecting slot to trigger the loading operation. Besides, when an 8 cm disc has been inserted into the loading/ejecting slot 102 without through the middle of the loading/ejecting slot, the 8 cm disc 130 could have touched the roller 104 without starting the loading operation. This raises lots of inconvenience to users for using an optical disc drive with slot loading mechanism.

### SUMMARY OF THE INVENTION

Accordingly, it is an object of the present invention to provide an apparatus for controlling the disc loading/ejecting operation in an optical disc drive that has a turntable and is able to access a larger disc with radius A and a smaller disc with radius B. The apparatus comprises a loading/ejecting slot, a roller for conveying an optical disc into or out of the optical disc drive, a first sensor being disposed at a first sensing position having a distance R1 between the center of the turntable and the first sensing position and B≦R1≦A, a second sensor being disposed at a second sensing position having a distance R2 between the center of the turntable and the second sensing position and R2≦B, a distance L between the second sensing position and the first sensing position and B≦L≦A, and a distance D between the second sensing position and the loading/ejecting slot and D≦2B, and a logical element for managing the loading/ejecting operation according to the outputs of the first and the second sensors and controlling a motor to drive a roller to load or eject the optical disc.

Furthermore, in one embodiment of the present invention, the distance L is approximately equal to B. And the larger disc with radius A is a 12 cm disc and 2A is 12 cm, and the smaller disc with radius B is an 8 cm disc and 2B is 8 cm. The first sensor and the second sensor are optical sensors and output a HIGH level or LOW level logical states to indicate if a disc has been detected. The first sensing position is on the virtual line between the turntable and the center of the loading/ejecting slot. The second sensing position is at a side of the virtual line between the turntable and the center of the loading/ejecting slot.

In one embodiment of the present invention, the logical element is a hard-wired logic circuitry or a microprocessor executing a firmware. And the logical element can share the same PCB with the first sensor and the second sensor.

It is another object of the present invention to provide a method for controlling the disc loading/ejecting operation in an optical disc drive by utilizing a logical element for managing the loading/ejecting operation according to the outputs of a first and a second sensors and controlling a motor to drive a roller to load or eject the optical disc. The method comprising steps to perform an ejecting operation until the second sensor outputs a first logical state, and to hold to wait for the first sensor having output transition from a second logical state to first logical state.

In one embodiment of the present invention, the first logical state is a HIGH level logical state and the second logical state is a LOW level logical state. The first sensor and the second sensor are optical sensors and output a HIGH level or LOW level logical states to indicate if a disc has been detected.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view for illustrating the relation between various elements in an optical disc drive with slot loading mechanism of the prior art after a disc has been loaded.

FIG. 2A is a top view for illustrating the optical disc drive with slot loading mechanism of the prior art when a disc has just been inserted into the loading/ejecting slot.

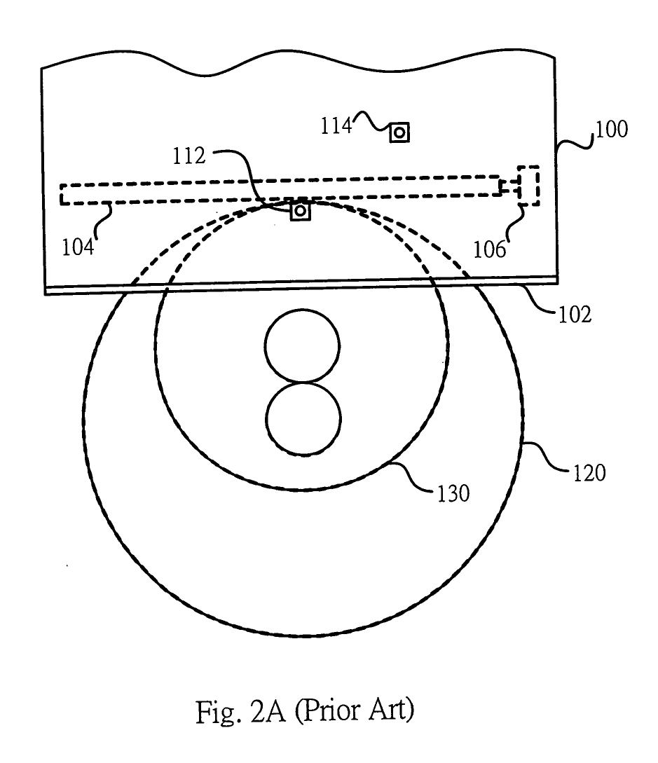

FIG. 2B is a top view for illustrating the optical disc drive with slot loading mechanism of the prior art when an 8 cm disc has been inserted into the loading/ejecting slot sidelong.

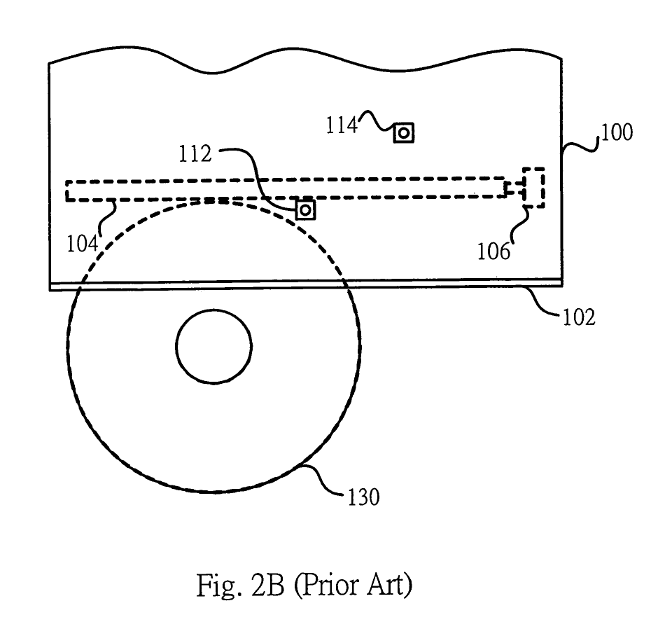

FIG. 3A is a top view for illustrating the optical disc drive with slot loading mechanism of the prior art when an 8 cm disc or a 12 cm disc has been ejected from the optical disc drive.

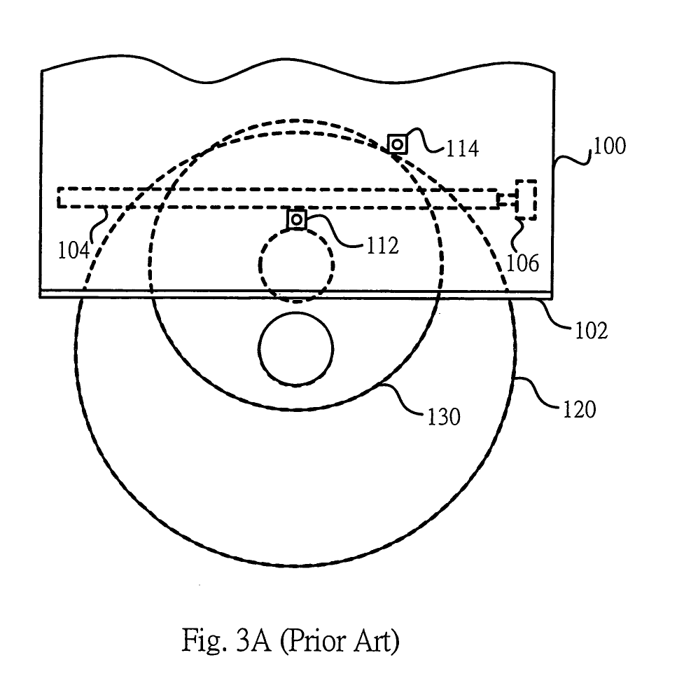

FIG. 3B is a time diagram illustrating the output of the first sensor in an optical disc drive with slot loading mechanism of the prior art after an ejecting operation is performed.

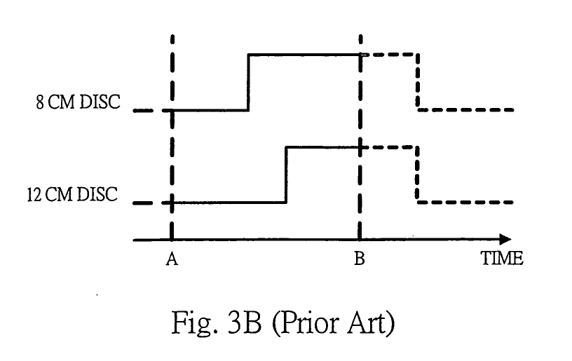

FIG. 4 is a flow chart illustrating the method for controlling the disc loading operation in an optical disc drive with slot loading mechanism of the prior.

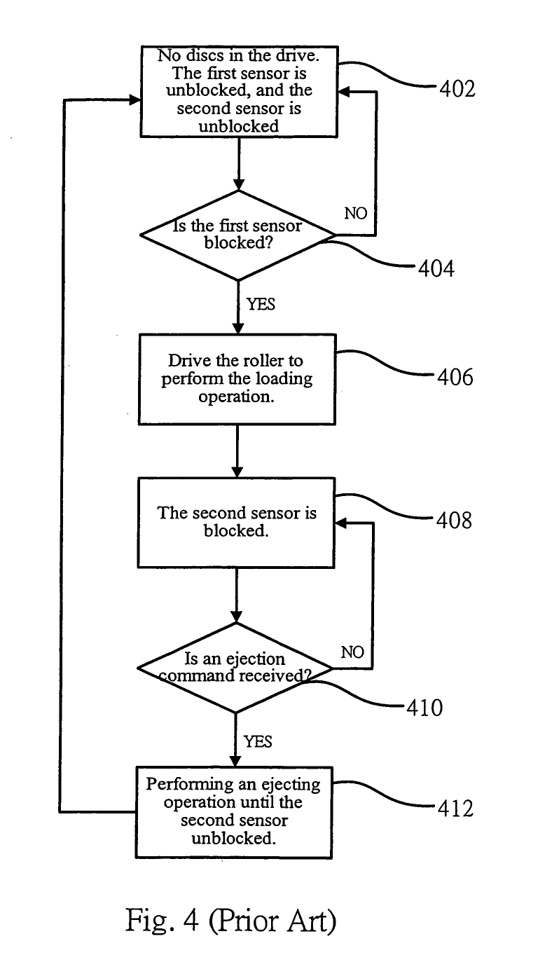

FIG. 5 is a top view for illustrating the relation between various elements in an optical disc drive according to the present invention.

FIG. 6 is a top view for illustrating the optical disc drive according to the present invention when a disc has just been inserted into the loading/ejecting slot.

FIG. 7A is a top view for illustrating the optical disc drive according to the present invention when an 8cm disc or a 12 cm disc has been ejected from the optical disc drive.

FIG. 7B is a time diagram illustrating the output of the first sensor in an optical disc drive according to the present invention after an ejecting operation is performed.

FIG. 8 is a flow chart illustrating the method for controlling the disc loading operation in an optical disc drive according to the present invention.

### DESCRIPTION OF THE EMBODIMENTS

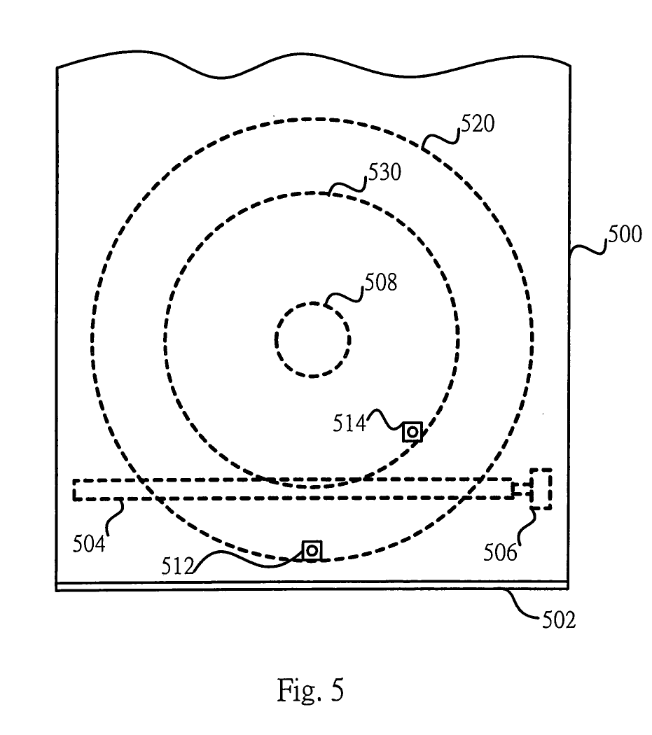

Please refer to FIG. 5. FIG. 5 is a top view for illustrating the relation between various elements in an optical disc drive according to the present invention. Some components are not explained in detail for the sake of not to unnecessarily obscure the description of the present invention. For controlling the slot loading mechanism, an optical disc drive 500 according to the present invention has a loading/ejecting slot 502, a first sensor 512 disposed at a first sensing position for detecting if a disc passing the first sensing position, and a second sensor 514 disposed at a second sensing position for detecting if a disc passing the second sensing position. In FIG. 5, there are also two round contours for showing the positions of two regular sizes of the loaded optical disc: one is for a 12 cm disc 520, and the other is for an 8 cm disc 530. The first sensor 512 is designed to trigger the loading operation and to help to decide if a loaded disc is a 12 cm disc. Thus a distance R1 between the center of the turntable and the first sensing position for deposing the first sensor 512 is larger than the radius of the 8 cm disc 530 and smaller than the radius of the radius of the 12 cm disc 520.

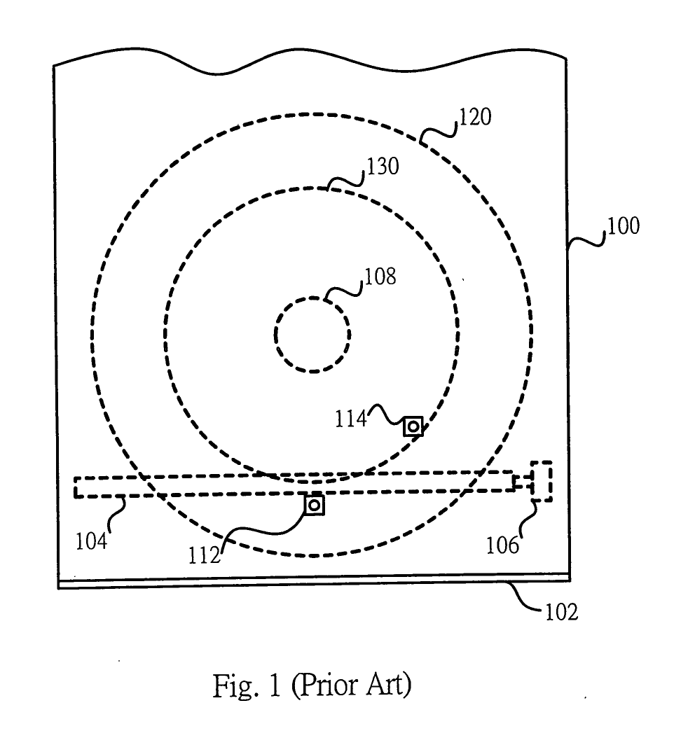

After a disc is loaded into the disc drive, the disc is fixed on a turntable 508 of the spindle motor. A logical element (Not Shown) manages the status of the loading/ejecting operation according to the outputs of the first and the second sensors and controls a motor (Not Shown) to drive a roller 504 via a gear set 506 to load or eject the optical disc. The roller 504 is used to convey optical discs into or out of the disc drive according to the rotating direction of the roller 504. In the preferred embodiment according to the present invention, the sensors are optical sensors that each has an emitter and a receiver to emit and receive a light beam, respectively. For example, when a disc is passing an optical sensor, the light beam from the emitter is blocked by the disc and the sensor has an out put at the LOW level. On the other hand, when the sensor is not blocked by the disc, the sensor has an out put at the HIGH level. Furthermore, the logical element for managing the loading and ejecting operations can be a hard-wired logic circuitry or a microprocessor executing a firmware. And in some embodiments, the logical element can even share the same PCB with the first and the second sensor. As shown in FIG. 5, the first position for deposing the first sensor 512 according to the present invention has been moved toward the loading/ejecting slot 502 than it was in the prior art as shown in FIG. 1. However, the actions after a disc being loaded into the disc drive 500 are similar to the prior art shown in FIG. 1.

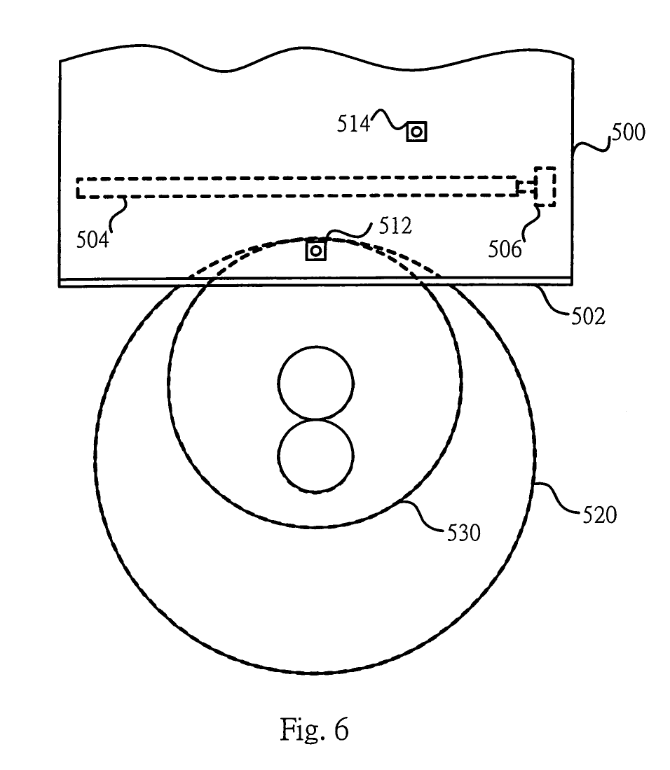

Now refer to FIG. 6. FIG. 6 is a top view for illustrating the optical disc drive according to the present invention when a disc has just been inserted into the loading/ejecting slot 502. According to the present invention, the first position for disposing the first sensor 512 has been moved outward while comparing it to the sensor 112 in the prior art. More specifically, the distance between the first sensor 512 and the loading/ejecting slot 502 according to the present invention is not longer than the distance the first sensor 512 and the roller 504. While a 12 cm disc 520 or a 8 cm disc 530 has been inserted into the loading/ejecting slot 502, the logical element (Not Shown) recognizes that the disc should be loaded into the disc drive if the disc blocks the first sensor 512. Even the 8 cm disc 530 being inserted via the aside of the loading/ejecting slot 502, the first sensor 512 according to the present invention can sense the disc and initiate the loading operation effectively. Then the logical element gives instructions to drive the roller 504 for conveying the disc into the drive and fixed the disc on the turntable.

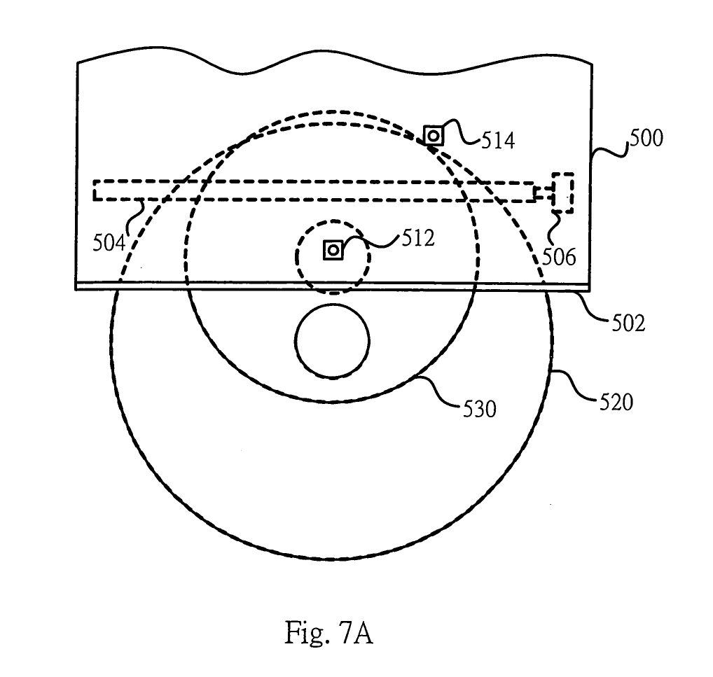

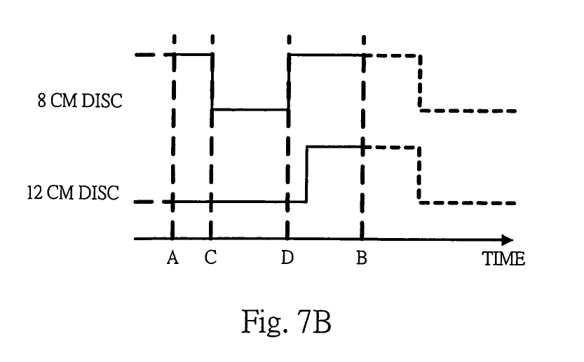

Now refer to FIG. 7A. FIG. 7A is a top view for illustrating the optical disc drive according to the present invention when an 8cm disc 530 or a 12 cm disc 520 has been ejected from the optical disc drive. As shown in the diagram, the second sensor 514 can be used to decide when to stop the roller 504 during the ejecting operation. When the logical element receives commands to eject a disc inside the optical disc drive, the logical element gives instructions to drive the roller 504 for conveying the disc out of the drive 500 until the second sensor 514 no longer being blocked by the disc. Since the second sensor 514 can also help to determine if there is a disc inside the optical disc drive 500 or not, the distance R2 between the center of the turntable 508 and the second position for deposing the second sensor 514 should be less than the radius of an 8 cm disc. Moreover, for users to handle the disc after ejecting operation, a distance D between the second sensor 514 and the loading/ejecting slot 502 should be less than the diameter of an 8 cm disc 530. And a distance L between the second sensing position and the first sensing position is no less than the radius of an 8 cm disc 530 and no more than the radius of a 12 cm disc 520, preferably approximately equal to the radius of an 8 cm disc 530, since the first sensor 512 has been moved outward according to the present invention.

Please refer to FIG. 7B. FIG. 7B is a time diagram illustrating the output of the first sensor 512 in an optical disc drive according to the present invention after an ejecting operation is performed. At the time point A, the second sensor 514 has just been unblocked (for example, a HIGH level output, not shown in FIG. 7B) and the ejecting operation has just been done. If a 12 cm disc 520 is used, the disc blocks the first sensor 512 (for example, a LOW level output) at this time as mentioned in prior art. However, owing to the first sensor 512 being moved forward according to the present invention, an 8 cm disc 530 nay not be able to block the first sensor 512 (for example, a HIGH level output) as shown in the figure for the central hole of the 8 cm disc 530 may just reach the first sensing position. Then users remove the disc from the disc, the first sensor 512 will become unblocked and output a HIGH level logical state. This results in the first sensor 512 being blocked first (at time point C) and then unblocked (at time point D) during users removing the disc if a 8cm disc is used. By using the method for controlling the disc loading/ejecting operation of the prior art with the sensors according to the present invention in the optical disc drive, the logical element will take the LOW level output of the first sensor 512 at time point C as a signal to prepare for next loading operation if an 8 cm disc 530 is used. Thus it will mistakenly initiate a loading operation before time point B when an 8 cm disc is actually being removed.

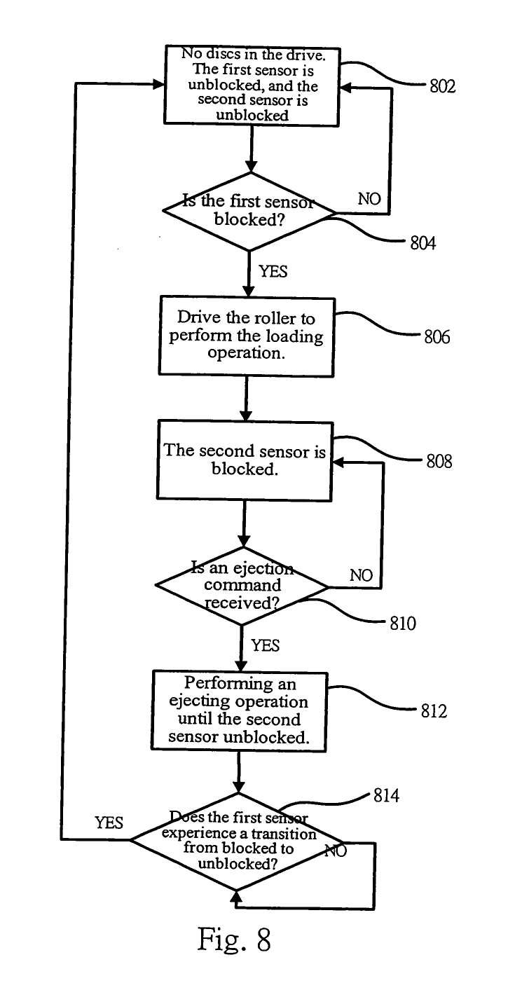

Please refer to FIG. 8. FIG. 8 is a flow chart illustrating the method for controlling the disc loading operation in an optical disc drive 500 according to the present invention. Presume that there is no disc inside the optical disc drive 500 at beginning according to the flow chart. In step 802, when the first sensor 512 output a HIGH level logical state (sensor unblocked) and the second sensor 514 HIGH level logical state (sensor unblocked), it indicates that there are no discs inside the optical disc drive 500 for the logical element. Then in the step 804, the logical element monitors if the logical state of the first sensor 512. Once first sensor 512 outputs a LOW level logical state (sensor blocked), the progress moves into step 806 and the logical element gives instructions to drive the roller 504 to perform a loading operation. After the loading operation is done, the progress moves into step 808 and the output of the second sensor 514 should be at LOW level logical state (sensor blocked). Following, in the step 810, the logical element monitors if an ejection command is received. If an ejection command is received, the progress moves to step 812 and the logical element gives instructions to drive the roller 504 to perform a ejecting operation until the second sensor 514 outputs a HIGH level logical state (sensor unblocked).

Next, the progress goes to step 814 after the second sensor 514 outputs a HIGH level logical state in step 812. To avoid the problem mentioned above that the logical element may take the LOW level output of the first sensor 512 at time point C in FIG. 7B as a signal to initiate a loading operation if an 8 cm disc 530 is actually being removed, the logical element holds to wait for this transition of the first sensor in step 814. The first sensor 512 will experience a transition from a LOW level output to a HIGH level output no matter what kind of disc is used. If no, the logical element continues to monitor the first sensor 512. If the transition of the output is sensed by the logical element, the disc can be thought as being removed by users and the ejecting process is completed. Now the progress can return to step 802 for next insertion of discs

While the present invention has been particularly shown and described with reference to a preferred embodiment, it will be understood by those skilled in the art that various changes in form and detail may be without departing from the spirit and scope of the present invention.

1. An apparatus for controlling the disc loading/ejecting operation in an optical disc drive that has a turntable and is able to access a larger disc with radius A and a smaller disc with radius B, the apparatus comprising:
a loading/ejecting slot;
a roller for conveying an optical disc into or out of the optical disc drive;
a first sensor being disposed at a first sensing position having a distance R1 between the center of the turntable and the first sensing position and B≦R1≦A;
a second sensor being disposed at a second sensing position having a distance R2 between the center of the turntable and the second sensing position and R2≦B, a distance L between the second sensing position and the first sensing position and B≦L≦A, and a distance D between the second sensing position and the loading/ejecting slot and D≦2B; and
a logical element for managing the loading/ejecting operation according to the outputs of the first and the second sensors and controlling a motor to drive a roller to load or eject the optical disc.

2. The apparatus for controlling the disc loading/ejecting operation in an optical disc drive according to claim 1, wherein the distance L is approximately equal to B.

3. The apparatus for controlling the disc loading/ejecting operation in an optical disc drive according to claim 1, wherein the larger disc with radius A is a 12 cm disc and 2A is 12 cm.

4. The apparatus for controlling the disc loading/ejecting operation in an optical disc drive according to claim 1, wherein the smaller disc with radius B is an 8 cm disc and 2B is 8 cm.

5. The apparatus for controlling the disc loading/ejecting operation in an optical disc drive according to claim 1, wherein the first sensor and the second sensor are optical sensors and output a HIGH level or LOW level logical states to indicate if a disc has been detected.

6. The apparatus for controlling the disc loading/ejecting operation in an optical disc drive according to claim 1, wherein the first sensing position is on the virtual line between the turntable and the center of the loading/ejecting slot.

7. The apparatus for controlling the disc loading/ejecting operation in an optical disc drive according to claim 1, wherein the second sensing position is at a side of the virtual line between the turntable and the center of the loading/ejecting slot.

8. The apparatus for controlling the disc loading/ejecting operation in an optical disc drive according to claim 1, wherein the logical element is a hard-wired logic circuitry or a microprocessor executing a firmware.

9. The apparatus for controlling the disc loading/ejecting operation in an optical disc drive according to claim 1, wherein the logical element shares the same PCB with the first and the second sensors.

10. A method for controlling the disc loading/ejecting operation in an optical disc drive that has a turntable and is able to access a larger disc with radius A and a smaller disc with radius B by utilizing a logical element for managing the loading/ejecting operation according to the outputs of a first and a second sensors and controlling a motor to drive a roller to load or eject the optical disc, the method comprising:
performing an ejecting operation until the second sensor outputs a first logical state; and
holding to wait for the first sensor having output transition from a second logical state to first logical state before a next loading operation;
wherein the first sensor is disposed at a first sensing position having a distance R1 between the center of the turntable and the first sensing position and B≦R1≦A, and the second sensor being disposed at a second sensing position having a distance R2 between the center of the turntable and the second sensing position and R2≦B, and a distance L between the first and the second sensors is approximately equal to B.

11. The method for controlling the disc loading/ejecting operation in an optical disc drive according to claim 10, wherein the first logical state is a HIGH level logical state and the second logical state is a LOW level logical state.

12. The method for controlling the disc loading/ejecting operation in an optical disc drive according to claim 10, wherein the first sensor and the second sensor are optical sensors and output a HIGH level or LOW level logical states to indicate if a disc has been detected.
